(19) United States
(12) Patent Application Publication
(10) Pub. No.: US 2019/0302642 A1
(43) Pub. Date: Oct. 3, 2019

(54) IMAGE DEVELOPMENT UNIT AND IMAGE FORMATION DEVICE

(71) Applicant: Oki Data Corporation, Tokyo (JP)

(72) Inventor: Toshiharu SATO, Tokyo (JP)

(73) Assignee: Oki Data Corporation, Tokyo (JP)

(21) Appl. No.: 16/354,174

(22) Filed: Mar. 15, 2019

(30) Foreign Application Priority Data
Mar. 27, 2018 (JP) 2018-060080

(51) Int. Cl. G03G 15/08

(52) U.S. Cl. CPC G03G 15/0808; G03G 15/0812

(57) ABSTRACT

An image development unit according to an aspect of one or more embodiments may include: an electrostatic latent image carry member that carries an electrostatic latent image; and an image development member that attaches toner to the electrostatic latent image and includes a surface with a skewness Rsk of 1.06 to 1.75 inclusive.

### CROSS REFERENCE TO RELATED APPLICATIONS

This application claims priority based on 35 USC 119 from prior Japanese Patent Application No. JP2018-060080 filed on Mar. 27, 2018, entitled “IMAGE DEVELOPMENT UNIT AND IMAGE FORMATION DEVICE”, the entire contents of which are incorporated herein by reference.

### BACKGROUND

This disclosure relates to an image development unit that attaches toner to an electrostatic latent image, and an image formation device including the image development unit.

Image formation devices of an electrophotographic scheme have been widely used due to their advantages, over image formation devices of other schemes such as an ink-jet scheme, in that a clear image can be obtained in a short time.

An image formation device of the electrophotographic scheme (hereinafter simply referred to as “image formation device”) includes a photoreceptor drum that carries an electrostatic latent image, and an image development roller that attaches toner to the electrostatic latent image. In the process of image formation, toner is attached to an electrostatic latent image and transferred onto a medium to form an image on the medium.

The configuration of the image formation device affects the quality of an image, and thus various kinds of disclosures have been made for the configuration of the image formation device. Specifically, the roughness (ten-point average roughness Rz, for example) of the surface of the image development roller in the circumferential direction is defined to prevent the toner from being firmly fixed to the surface of the image development roller (refer to Japanese Patent Application Publication No. 2015-184601, for example).

### SUMMARY

Various kinds of disclosures have been made for the configuration of an image formation device, but the image quality is not sufficient yet, and thus improvement is needed.

An object of an aspect of one or more embodiments may provide an image development unit and an image formation device that are capable of forming a high-quality image.

An aspect of one or more embodiments may be an image development unit that includes: an electrostatic latent image carry member that carries an electrostatic latent image; and an image development member that attaches toner to the electrostatic latent image and includes a surface with a skewness Rsk of 1.06 to 1.75 inclusive.

Another aspect of one or more embodiments may be an image development unit that includes: an electrostatic latent image carry member that carries an electrostatic latent image; and an image development member that attaches toner to the electrostatic latent image and includes a conductive shaft member and a conductive elastic layer covering a surface of the shaft member. The elastic layer contains a plurality of particles, the plurality of particles includes a first particle with a median diameter D50 of 3 μm to 7 μm inclusive, and a second particle with a median diameter D50 of 10 μm to 20 μm inclusive, and a ratio of the weight of the second particles relative to the weight of the first particles is 0.25 to 1.00 inclusive.

According to at least one of the above-described aspects, a high-quality image can be formed.

### BRIEF DESCRIPTION OF DRAWINGS

FIG. 1 is a diagram illustrating a plan view of a configuration of an image formation device according to one or more embodiments;

FIG. 2 is a diagram illustrating an enlarged plan view of a configuration of an image development unit illustrated in FIG. 1;

FIG. 3 is a diagram illustrating an enlarged plan view of a configuration of an image development roller illustrated in FIG. 2;

FIG. 4 is a diagram illustrating a schematic cross-sectional view of a configuration in the vicinity of the surface of the image development roller;

FIG. 5 is a diagram illustrating a schematic cross-sectional view of another configuration in the vicinity of the surface of the image development roller;

FIG. 6 is a diagram illustrating a roughness curve of the surface of the image development roller; and

FIG. 7 is a block diagram of a configuration of the image formation device illustrated in FIG. 1.

### DETAILED DESCRIPTION

Descriptions are provided hereinbelow for embodiments based on the drawings. In the respective drawings referenced herein, the same constituents are designated by the same reference numerals and duplicate explanation concerning the same constituents is omitted. All of the drawings are provided to illustrate the respective examples only.

The description is made in the following order.

1. Image formation device
1-1. Entire configuration
1-2. Configuration of image development unit
1-3. Configuration and property of image development roller
1-4. Block configuration

### 1-5. Operation

1-6. Operations and effects

### 2. Modifications

### <1. Image Formation Device>

The following describes an image formation device according to an embodiment. An image development unit according to the embodiment is a component of the image formation device described below, and thus the description is also made on the image development unit.

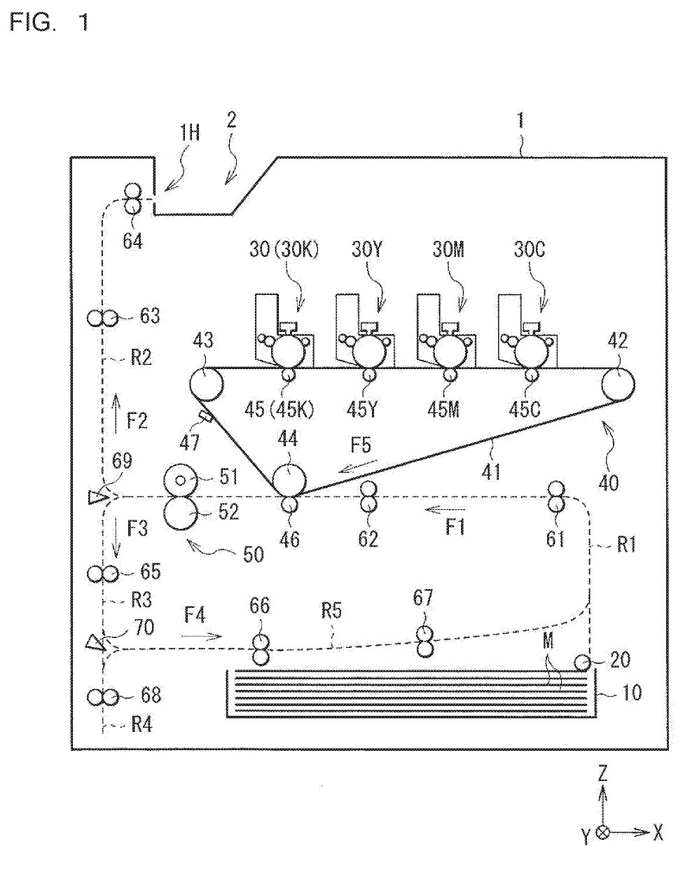

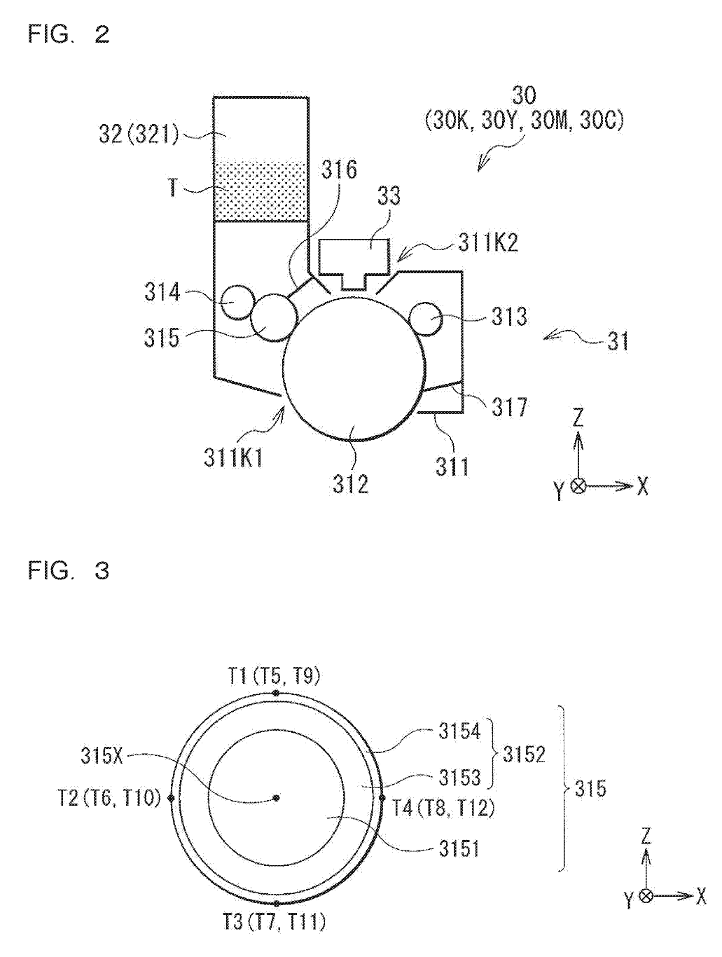

The image formation device is a device that forms an image on a medium M (refer to FIG. 1) by using toner T (refer to FIG. 2) as described later, and is what is called a full-color printer of an electrophotographic scheme. More specifically, the image formation device is, for example, an image formation device of an intermediate transfer scheme, which uses an intermediate transfer belt 41 (refer to FIG. 1) to be described later.

The kind of the medium M is not particularly limited, but is any one or two of paper, film, and the like.

### <1-1. Entire Configuration>

The following first describes the entire configuration of the image formation device. FIG. 1 illustrates a plane configuration of the image formation device. In the process of image formation, the medium M is conveyed along each of conveyance paths R1 to R5 illustrated with dashed lines in the image formation device.

Specifically, as illustrated in FIG. 1, the image formation device includes, for example, inside a housing 1, a tray 10, a feed roller 20, an image development unit 30, a transfer unit 40, a fixation unit 50, conveyance rollers 61 to 68, and conveyance path switching guides 69 and 70. The housing 1 is provided with, for example, a discharge port 1H and a stacker 2. For example, the medium M on which an image is formed is discharged to the stacker 2 through the discharge port 1H.

For example, the image formation device can switch the conveyance direction of the medium M by using the conveyance path switching guides 69 and 70 to form an image on one side (front surface) of the medium M or form images on both surfaces (front and back surfaces) of the medium M.

### [Tray and Feed Roller]

The tray 10 houses the medium M. For example, the tray 10 is detachably mounted in the housing 1. The tray 10 houses, for example, a plurality of the media M stacked on each other. The feed roller 20 is, for example, a cylindrical member extending in a Y-axis direction and rotatable about a rotational axis extending in the Y-axis direction. For example, the feed roller 20 takes out the media M housed in the tray 10 one by one.

Among a series of components of the image formation device to be described later, a component including the word “roller” in the name is a rotatable cylindrical member similarly to the feed roller 20 described above.

The number of trays 10 is not particularly limited and may be one, or two or more. Similarly, the number of feed rollers 20 is not particularly limited and may be one, or two or more. In this example, the image formation device includes one tray 10 and one feed roller 20.

### [Image Development Unit]

The image development unit 30 performs attachment processing (development processing) of the toner T to an electrostatic latent image. Specifically, for example, the image development unit 30 forms the electrostatic latent image and attaches the toner T to the electrostatic latent image by using Coulomb's force. For example, the image development unit 30 is detachably mounted on the housing 1.

The number of image development units 30 is not particularly limited and may be one, or two or more. In this example, the image formation device includes, for example, four image development units 30 (30K, 30Y, 30M, and 30C). For example, the image development units 30K, 30Y, 30M, and 30C are arrayed along the movement path of the intermediate transfer belt 41 to be described later. More specifically, the image development units 30K, 30Y, 30M, and 30C are disposed in the stated order from the upstream side toward the downstream side in the moving direction (Arrow F5) of the intermediate transfer belt 41.

For example, the image development units 30K, 30Y, 30M, and 30C have configurations identical to each other except for difference in the kind (color) of the toner T housed in a toner cartridge 32 (refer to FIG. 2) to be described later.

In this example, the image formation device includes four kinds of the toner T. Specifically, the toner cartridge 32 of the image development unit 30K houses, for example, black toner. The toner cartridge 32 of the image development unit 30Y houses, for example, yellow toner. The toner cartridge 32 of the image development unit 30M houses, for example, magenta toner. The toner cartridge 32 of the image development unit 30C houses, for example, cyan toner.

The configurations of the image development units 30K, 30Y, 30M, and 30C are described later in detail (refer to FIG. 2).

### [Transfer Unit]

The transfer unit 40 performs transfer processing by using the toner T subjected to the development processing by the image development unit 30. Specifically, for example, the transfer unit 40 transfers, onto the medium M, the toner T attached to the electrostatic latent image by the image development unit 30.

The transfer unit 40 includes, for example, the intermediate transfer belt 41, a drive roller 42, a driven roller 43, a backup roller 44, a primary transfer roller 45, a secondary transfer roller 46, and a cleaning blade 47.

The intermediate transfer belt 41 is an intermediate transfer medium onto which the toner T is temporarily transferred before transferred onto the medium M, and is, for example, an endless elasticity belt. For example, the intermediate transfer belt 41 is movable in the direction of Arrow F5 in accordance with rotation of the drive roller 42 while being stretched around the drive roller 42, the driven roller 43, and the backup roller 44.

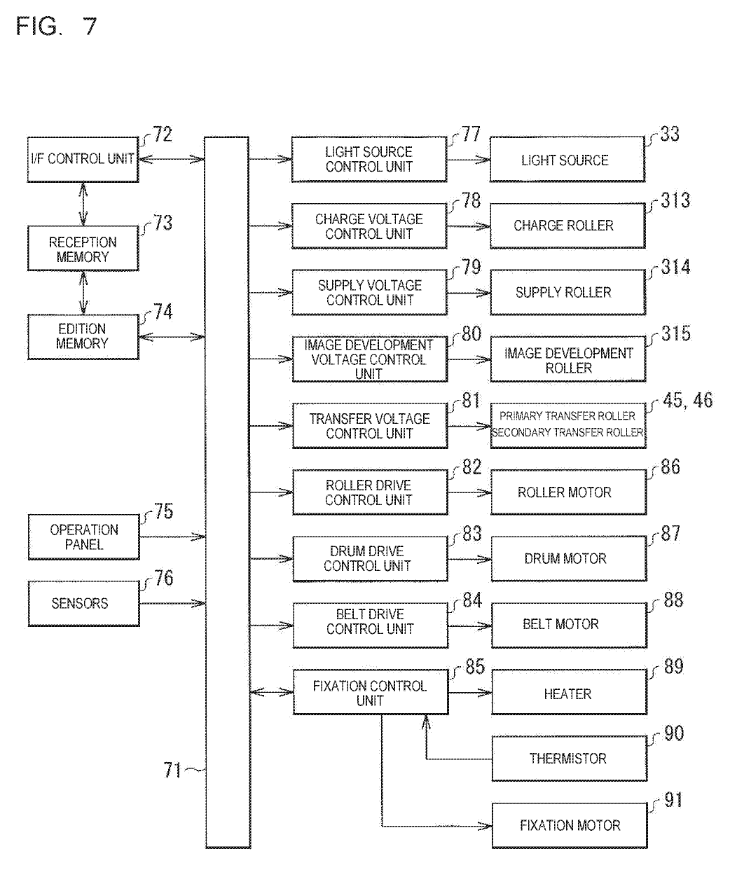

The drive roller 42 is rotatable through, for example, a roller motor 86 (refer to FIG. 7) to be described later. The driven roller 43 and the backup roller 44 are each rotatable in accordance with, for example, rotation of the drive roller 42.

The primary transfer roller 45 is made contact with a photoreceptor drum 312 (refer to FIG. 2) to be described later through the intermediate transfer belt 41 by pressing, and transfers (primary transfer) the intermediate transfer belt 41 onto the toner T attached to the electrostatic latent image.

The number of primary transfer rollers 45 is not particularly limited and may be one, or two or more. In the following, the image formation device includes, for example, four primary transfer rollers 45 (45K, 45Y, 45M, and 45C) corresponding to the four image development units 30 (30K, 30Y, 30M, and 30C) described above. The image formation device includes, for example, the single secondary transfer roller 46 corresponding to the single backup roller 44.

The secondary transfer roller 46 is made contact with the backup roller 44 by pressing, and transfers (secondary transfer), onto the medium M, the toner T transferred onto the intermediate transfer belt 41. The cleaning blade 47 is made contact with the intermediate transfer belt 41 by pressing, and scrapes off any foreign object such as unnecessary toner T remaining on the surface of the intermediate transfer belt 41.

### [Fixation Unit]

The fixation unit 50 performs fixation processing by using the toner T transferred onto the medium M by the transfer unit 40. Specifically, for example, the fixation unit 50 pressurizes, while heating, the medium M onto which the toner T is transferred by the transfer unit 40, thereby fixing the toner T to the medium M.

The fixation unit 50 includes, for example, a heating roller 51 and a pressing roller 52. The heating roller 51 heats the toner T transferred onto the medium M. The pressing roller 52 is made contact with the heating roller 51 by pressing, and pressurizes the toner T transferred onto the medium M.

The heating roller 51 includes, for example, a hollow cylindrical core metal, a heat-resistant elastic layer covering the surface of the core metal, and a tube layer covering the surface of the heat-resistant elastic layer. The core metal contains, for example, a metallic material such as aluminum. The heat-resistant elastic layer contains, for example, a rubber material such as silicone rubber. The tube layer contains, for example, tetrafluoroethylene-perfluoro alkyl vinyl ether copolymer (PFA). A heating source such as a heater 89 (refer to FIG. 7) to be described later is installed inside the heating roller 51 (core metal). A temperature measurement element such as a thermistor 90 (refer to FIG. 7) to be described later is disposed near the heating roller 51 while being separated from the heating roller 51. The heater 89 heats, for example, the heating roller 51, and the thermistor 90 measures, for example, the surface temperature of the heating roller 51. The heater 89 includes, for example, a halogen lamp.

The pressing roller 52 has a configuration same as that of the heating roller 51 except that, for example, no heater 89 nor thermistor 90 are attached to the pressing roller 52.

### [Conveyance Roller]

The conveyance rollers 61 to 68 each include a pair of rollers disposed oppositely to each other through the corresponding one of the conveyance paths R1 to R5, and convey the medium M taken out by the feed roller 20.

When an image is formed only on one side (front surface) of the medium M, the medium M is conveyed, for example, along the conveyance paths R1 and R2 by the conveyance rollers 61 to 64. When images are formed on both surfaces (front and back surfaces) of the medium M, the medium M is conveyed, for example, along the conveyance paths R1 to R5 by the conveyance rollers 61 to 68.

### [Conveyance Path Switching Guide]

The conveyance path switching guides 69 and 70 each switch the conveyance direction of the medium M in accordance with the format of an image formed on the medium M. The image format includes, for example, a format (one-side image formation mode) in which an image is formed only on one side of the medium M, and a format (both-side image formation mode) in which images are formed on both surfaces of the medium M.

### <1-2. Configuration of Image Development Unit>

The following describes the configuration of the image development unit 30. FIG. 2 illustrates an enlarged diagram of a plane configuration of the image development unit 30 (30K, 30Y, 30M, or 30C) illustrated in FIG. 1.

The image development units 30K, 30Y, 30M, and 30C each include, for example, a development processing unit 31 and the toner cartridge 32 as illustrated in FIG. 2. For example, a light source 33 is attached to the development processing unit 31. For simplification of illustration, FIG. 2 only illustrates the toner T inside the toner cartridge 32 (a housing chamber 321 to be described later). However, the toner T supplied from the toner cartridge 32 may exist inside the development processing unit 31 (a housing 311 to be described later).

### [Development Processing Unit]

The development processing unit 31 performs the development processing by using the toner T supplied from the toner cartridge 32. As illustrated in FIG. 2, the development processing unit 31 includes, for example, inside the housing 311, the photoreceptor drum 312, a charge roller 313, a supply roller 314, an image development roller 315, an image development blade 316, and a cleaning blade 317. The photoreceptor drum 312 is an “electrostatic latent image carry member” of this disclosure. The supply roller 314 is a “supply member” of this disclosure. The image development roller 315 is an “image development member” of this disclosure. The image development blade 316 is a “regulation member” of this disclosure.

The housing 311 is provided with, for example, an opening unit 311K1 to partially expose the photoreceptor drum 312, and an opening unit 311K2 to guide light output from the light source 33 to the photoreceptor drum 312. The toner cartridge 32 is detachably mounted on, for example, the housing 311. The light source 33 is disposed, for example, out of the housing 311.

### (Photoreceptor Drum, Charge Roller, Supply Roller, and Image Development Roller)

The photoreceptor drum 312 is an organic photoreceptor that carries the electrostatic latent image, and is, for example, a rotatable cylindrical member, similarly to the feed roller 20 described above. The photoreceptor drum 312 includes, for example, a cylindrical conductive carrier, and a photoconductive layer covering the surface (outer peripheral surface) of the conductive carrier. The conductive carrier contains a metallic material such as aluminum, and is what is called a metal pipe. The photoconductive layer has a multi-layer structure including, for example, an electric charge generation layer and an electric charge transport layer. For example, a blocking layer may be interposed between the conductive carrier and the photoconductive layer.

The charge roller 313 is rotatable in contact (by pressing) with the photoreceptor drum 312, and electrically charges the surface of the photoreceptor drum 312. The charge roller 313 includes, for example, a shaft, and a semiconductive layer covering the surface of the shaft. The shaft contains, for example, a metallic material such as stainless steel, and the semiconductive layer contains, for example, epichlorohydrin rubber. The charge roller 313 rotates, for example, in accordance with rotation of the photoreceptor drum 312.

The supply roller 314 is rotatable in contact (by pressing) with the image development roller 315, and supplies the toner T to the image development roller 315. The supply roller 314 includes, for example, a shaft, and a semiconductive layer covering the surface of the shaft. The shaft contains, for example, a metallic material such as stainless steel, and the semiconductive layer contains, for example, semiconductive foamed silicone. The supply roller 314 is, for example, what is called a sponge roller. The supply roller 314 rotates, for example, at a circumferential speed in a predetermined ratio relative to that of the image development roller 315.

The image development roller 315 is rotatable in contact (by pressing) with the photoreceptor drum 312. The image development roller 315 holds the toner T supplied from the supply roller 314, and attaches the toner T to the electrostatic latent image formed on the surface of the photoreceptor drum 312. The image development roller 315 rotates, for example, at a circumferential speed in a predetermined ratio relative to that of the photoreceptor drum 312. The configuration of the image development roller 315 is described later in detail (refer to FIG. 3).

### (Image Development Blade)

The image development blade 316 is a plate elastic member that regulates the thickness of the toner T supplied to the image development roller 315. The image development blade 316 contains, for example, one kind or two or more kinds of metallic materials such as stainless steel. Part of the image development blade 316 is disposed, for example, at a position separated from the image development roller 315 by a predetermined distance to control the thickness of the toner T based on the distance (interval) between the image development roller 315 and the image development blade 316.

### (Cleaning Blade)

The cleaning blade 317 is a plate elastic member that scrapes off any foreign object such as unnecessary toner T remaining on the surface of the photoreceptor drum 312. The cleaning blade 317 extends, for example, in a direction substantially parallel to a direction in which the photoreceptor drum 312 extends, and is made contact with the photoreceptor drum 312 by pressing. The cleaning blade 317 contains, for example, urethane rubber.

### [Toner Cartridge]

The toner cartridge 32 houses the toner T. As illustrated in FIG. 2, the toner cartridge 32 includes, for example, the housing chamber 321 housing the toner T. The toner T housed in the housing chamber 321 is supplied to the development processing unit 31 as necessary. Although FIG. 2 only illustrates the toner T inside the toner cartridge 32 for simplification of illustration, the toner T also exists inside the development processing unit 31 (housing 311).

The toner T is, for example, negative charging toner of a one-component image development scheme. In the one-component image development scheme, an appropriate amount of charge is applied to the toner T without using carriers (magnetism particles) for applying electric charge to the toner T. In the above-described scheme called a two-component scheme, however, carriers are mixed into the toner T, and an appropriate amount of charge is applied to the toner T by using friction between the carriers and the toner T.

The toner T contains, for example, a colorant and a binder. However, the toner T may further contain, for example, one kind or two or more kinds of other materials such as a release agent, a charging control agent, and an external additive. For example, the black toner, the yellow toner, the magenta toner, and the cyan toner have configurations identical to each other except for, difference in the kind of colorant.

The colorant of the black toner is, for example, pigment such as carbon black. The colorant of the yellow toner is, for example, pigment such as pigment yellow (for example, C. I. Pigment Yellow 185). The colorant of the magenta toner is pigment such as quinacridone (for example, C. I. Pigment Red 122). The colorant of the cyan toner is, for example, pigment such as copper phthalocyanine (for example, C. I. Pigment Blue 15).

The binder is, for example, a polymer material such as polyester resin. The release agent is, for example, wax such as aliphatic hydrocarbon wax. The charging control agent is, for example, a complex such as an azo complex. The external additive is, for example, an inorganic material such as titanium oxide, aluminum oxide, or silicon oxide.

The method of manufacturing the toner T is not particularly limited, but may be, for example, a grinding method, a polymerization method, or any other method. The polymerization method is, for example, an emulsion polymerization condensation method or a dissolution suspension method.

### [Light Source]

The light source 33 is an exposure device that exposes the surface of the photoreceptor drum 312 to form the electrostatic latent image on the surface of the photoreceptor drum 312. The light source 33 is, for example, an LED head including a light-emitting diode (LED) element and a lens array. The LED element and the lens array are disposed, for example, so that light output from the LED element images on the surface of the photoreceptor drum 312.

### <1-3. Configuration and Property of Image Development Roller>

The following describes the configuration and property of the image development roller 315.

### [Configuration of Image Development Roller]

FIG. 3 illustrates an enlarged diagram of a plane configuration of the image development roller 315 illustrated in FIG. 2. As illustrated in FIG. 3, for example, the image development roller 315 extends in the Y-axis direction, and is rotatable about a rotational axis 315X extending in the Y-axis direction. The image development roller 315 includes, for example, a shaft 3151 and a cover layer 3152. The shaft 3151 is a “shaft member” of this disclosure. The cover layer 3152 is an “elastic layer” of this disclosure.

### (Shaft)

The shaft 3151 is, for example, a cylindrical member extending in the Y-axis direction. The shaft 3151 contains, for example, one kind or two or more kinds of conductive materials such as metallic materials having stiffness and conductivity. The metallic materials are, for example, iron, copper, brass, stainless steel, aluminum, and nickel. However, the conductive materials are not limited to limited the metallic materials, but may be resin materials containing dispersed conductive particles, or ceramics materials.

The shape of the shaft 3151 is not particularly limited but may be any cylindrical shape. Thus, the shaft 3151 may have, for example, a non-hollow cylindrical shape or a hollow cylindrical shape (pipe shape). In such a case, for example, part (for example, a leading end part) of the shaft 3151 may be narrowed, in other words, the shaft 3151 may have a partially small outer diameter. The shaft 3151 may be provided with a gear mounting step or a pin hole as necessary.

### (Cover Layer)

The cover layer 3152 covers the surface (outer peripheral surface) of the shaft 3151, and has conductivity and elasticity. The cover layer 3152 has elasticity to achieve close contact of the image development roller 315 to the photoreceptor drum 312 when the photoreceptor drum 312 is made contact with the image development roller 315 by pressing. The cover layer 3152 includes, for example, an inner side layer 3153 and a surface layer 3154. The inner side layer 3153 is a “first elastic layer” of this disclosure. The surface layer 3154 is a “second elastic layer” of this disclosure.

### (Inner Side Layer)

The inner side layer 3153 covers the surface of the shaft 3151, and contains, for example, one kind or two or more kinds of resin materials (rubber materials) such as urethane rubber, acrylonitrile butadiene rubber (NBR), styrene butadiene rubber (SBR), ethylene propylene diene rubber (EPDM), and silicone rubber. In particular, silicone rubber is preferable. This is because the elasticity of the cover layer 3152 is improved to facilitate close contact of the image development roller 315 to the photoreceptor drum 312.

The inner side layer 3153 may contain one kind or two or more kinds of conductive materials to achieve or improve conductivity. Examples of the conductive materials include an electronic conduction agent and an ionic conduction agent. The electronic conduction agent is, for example, conductive filler such as carbon black.

The inner side layer 3153 is formed by, one kind or two or more kinds of shaping methods using a composition (resin composition) containing a resin material as the formation material of the inner side layer 3153, for example. The shaping method is, for example, an extrusion molding method, a press shaping method, and a mold shaping method. The mold shaping method is what is called an injection molding method using a mold. When the inner side layer 3153 is formed of the resin composition, the inner side layer 3153 in a sponge state containing air bubbles is formed by, for example, foaming and curing the resin composition by a known method.

A specific method of forming the inner side layer 3153 is, for example, as follows. In this example, the resin composition is a resin composition (silicone rubber composition) containing silicone rubber.

When the silicone rubber composition is an addition-curable millable conductive silicone rubber composition, for example, the extrusion molding method is employed. When the silicone rubber composition is an addition-curable liquid conductive silicone rubber composition, for example, the mold shaping method is employed.

Curing conditions (heating temperature and heating time) are not particularly limited. When the addition-curable millable conductive silicone rubber composition is used, the curing conditions include, for example, the heating temperature of 100° C. to 500° C., preferably 120° C. to 300° C., and the heating time of several seconds to one hour, preferably 10 seconds to 35 minutes. When the addition-curable liquid conductive silicone rubber composition is used, the curing conditions include, for example, the heating temperature of 100° C. to 300° C., preferably 110° C. to 200° C., and the heating time of five minutes to five hours, preferably one hour to three hours.

However, when the addition-curable millable conductive silicone rubber composition is used, secondary vulcanization may be performed under conditions of, for example, the heating temperature of 100° C. to 200° C. and the heating time of one hour to 20 hours. When the addition-curable liquid conductive silicone rubber composition is used, secondary vulcanization may be performed under conditions, for example, the heating temperature of 120° C. to 250° C. and the heating time of two hours to 70 hours.

After the inner side layer 3153 is formed, the outer diameter or surface state of the image development roller 315 may be adjusted by, for example, polishing or machining the surface of the inner side layer 3153. In addition, after the inner side layer 3153 is formed, a primer layer may be interposed between the inner side layer 3153 and the surface layer 3154 by forming the primer layer before the surface layer 3154 is formed on the inner side layer 3153.

### Surface Layer)

The surface layer 3154 covers the surface of the inner side layer 3153, and has various functions. Firstly, the surface layer 3154 facilitates charging of the toner T. Secondly, the surface layer 3154 facilitates release (separation) of the toner T from the surface of the image development roller 315. Thirdly, the surface layer 3154 prevents chemical contamination of the surface of the photoreceptor drum 312 due to contact with the image development roller 315 by pressing.

The surface layer 3154 contains, for example, an elastic material, and the elastic material contains, for example, one kind or two or more kinds of resin materials such as urethane resin. The urethane resin is formed through, for example, reaction between polyol and polyisocyanate. The polyisocyanate is, for example, aliphatic polyisocyanate or aromatic polyisocyanate. However, the polyisocyanate may be, for example, block polyisocyanate blocked by a block compound (block agent). The block compound is not limited to a particular kind but may be any compound that can bind to isocyanate group and can be desorbed from the isocyanate group in accordance with temperature or humidity. The block compound is, for example, ε-caprolactam, methyl ethyl ketoxime, 3,5-dimethyl pyrazole, alcohol, or phenol. Additionally, the block compound may be, for example, isocyanate. In this case, the block polyisocyanate is, for example, isocyanate dimer (polyurethodione). In particular, ε-caprolactam and methyl ethyl ketoxime are preferable. This is because ε-caprolactam and methyl ethyl ketoxime have excellent compatibility with an organic solvent and can be easily desorbed from the isocyanate group in accordance with heating.

The surface layer 3154 is formed by, for example, applying a composition (resin composition) containing a resin material as the formation material of the surface layer 3154 and then curing the resin composition by heating. In such a case, the resin composition may be directly applied, or solution (application liquid) may be prepared by dissolving the resin composition in a solvent and then applied.

The solvent is not limited to a particular kind, but may be a volatile solvent (organic solvent) or an aqueous solvent (water). The organic solvent is, for example, alcohol, an aromatic solvent, or an ester solvent. The alcohol is, for example, methanol or ethanol. The aromatic solvent is, for example, xylene or toluene. The ester solvent is, for example, acetic acid ethyl or acetic acid butyl.

The method of heating the resin composition is not particularly limited, but may be, for example, a heating method using a heater. The heating condition is not particularly limited, but includes, for example, the heating temperature of 100° C. to 200° C., preferably 120° C. to 160° C., and the heating time of 10 minutes to 120 minutes, preferably 30 minutes to 60 minutes.

Alternatively, the surface layer 3154 may be formed by, for example, a shaping method such as an extrusion molding method, a press shaping method, or a mold shaping method. In such a case, the resin composition may be shaped by the shaping method and then cured by heating.

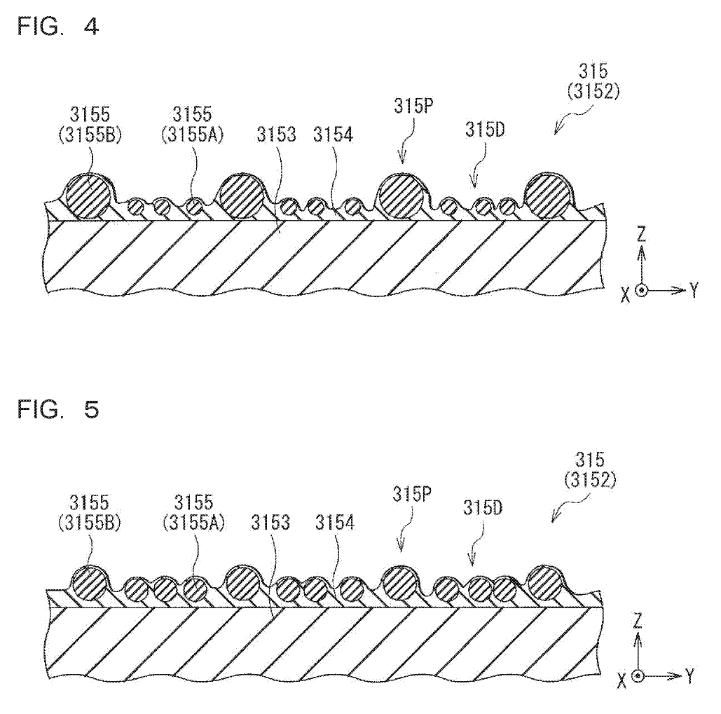

The image development roller 315 preferably contains particles 3155 on and near the surface thereof (refer to FIG. 4). More specifically, when the image development roller 315 contains the cover layer 3152 (the inner side layer 3153 and the surface layer 3154), it is preferable that the cover layer 3152 contains the particles 3155, and it is more preferable that the surface layer 3154 as the outermost layer contains the particles 3155. In other words, the surface layer 3154 preferably contains the particles 3155 together with the above-described elastic material. However, when the surface layer 3154 contains the particles 3155, the inner side layer 3153 may contain the particles 3155, too. The image development roller 315 contains the particles 3155 on and near the surface to facilitate appropriate adjustment of the surface roughness (skewness Rsk) by using the particles 3155 as described later.

Each particle 3155 contains, for example, one kind or two or more kinds of resin materials such as urethane resin, acrylic resin, and silicone resin. The particle 3155 containing the urethane resin is, for example, a polyurethane urea particle including a flexible particle body and a hard urea thin layer. The particle body contains, for example, polyurethane formed through reaction between polyisocyanate and polyol. For example, the urea thin layer covers the surface of the particle body, and is formed through reaction between polyisocyanate and bifunctional amine. The acrylic resin is, for example, acrylic resin or methacrylic resin. The acrylic resin is preferably non-conductive acrylic resin having no conductivity. The particle 3155 containing the acrylic resin is preferably not provided with surface reforming.

The particle 3155 is not limited to a particular average particle size. The average particle size is what is called a median diameter D50 (μm), and this applies in the following description. In particular, the particles 3155 preferably have two or more kinds of average particle sizes different from each other. The average particle size difference can be used to facilitate appropriate adjustment of the surface roughness (skewness Rsk) of the image development roller 315. The kinds (materials) of the particles 3155 having average particle sizes different from each other, and the values of the average particle sizes are not particularly limited as long as the surface roughness of the image development roller 315 is appropriately adjusted by using the particles 3155.

Specifically, when two kinds of the particles 3155 having two kinds of average particle sizes different from each other are used, for example, the particles 3155 of the first kind may have an average particle size of 3 μm to 7 μm and the particles 3155 of the second kind may have an average particle size of 8 μm to 9 μm; the particles 3155 of the first kind may have an average particle size of 8 μm to 9 μm and the particles 3155 of the second kind may have an average particle size of 10 μm to 20 μm; or the particles 3155 of the first kind may have an average particle size of 3 μm to 7 μm and the particles 3155 of the second kind may have an average particle size of 10 μm to 20 μm.

When three kinds of the particles 3155 having three kinds of average particle sizes different from one another are used, for example, the particles 3155 of the first kind may have an average particle size of 3 μm to 7 μm, the particles 3155 of the second kind may have an average particle size of 8 μm to 9 μm, and the particles 3155 of the third kind may have an average particle size of 10 μm to 20 μm.

### [Property of Image Development Roller]

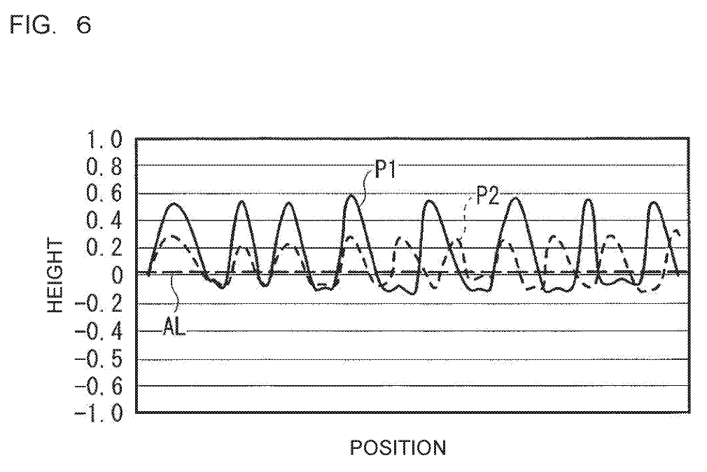

FIGS. 4 and 5 each schematically illustrate a section configuration in the vicinity of the surface of the image development roller 315. FIG. 6 illustrates the roughness curve (height profile) of the surface of the image development roller 315.

FIGS. 4 and 5 only illustrate part (the cover layer 3152) of the image development roller 315. In this case, the surface layer 3154 contains, for example, two kinds of the particles 3155 (3155A and 31556) having average particle sizes different from each other. For example, the average particle size of the particles 31556 is larger than the average particle size of the particles 3155A. The particles 3155A are “first particles” of this disclosure. The particles 31556 are “second particles” of this disclosure.

Specifically, the average particle size of the particles 3155A is, for example, 3 μm to 7 μm as described above, and the average particle size of the particles 3155B is, for example, 10 μm to 20 μm as described above.

The amount of the particles 3155 contained in the surface layer 3154 is not particularly limited. More specifically, the ratio (weight fraction M1:% by weight) of the weight of the particles 3155A relative to the weight of the elastic material is not particularly limited but may be optionally set. The ratio (weight fraction M2:% by weight) of the weight of the particles 31556 relative to the weight of the elastic material is not particularly limited but may be optionally set.

In particular, the ratio (weight fraction M:% by weight) of the sum of the weight of the particles 3155A and the weight of the particles 31556, in other words, the sum of the weight fractions M1 and M2, relative to the weight of the elastic material is preferably 35% by weight or lower. This is because appropriate adjustment of the surface roughness (skewness Rsk) of the image development roller 315 can be facilitated as described later.

The ratio (weight ratio Q) of the weight of the particles 31556 relative to the weight of the particles 3155A is not particularly limited but may be optionally set. In particular, the weight ratio Q is preferably 0.25 to 1.00. With this weight ratio Q, similarly to the above description of the weight fraction M, appropriate adjustment of the surface roughness (skewness Rsk) of the image development roller 315 is facilitated. The value of the weight ratio Q is a value rounded to two decimal places.

In FIG. 6, the horizontal axis represents a position in the direction (Y-axis direction) in which the image development roller 315 extends, and the vertical axis represents the height of the surface of the image development roller 315. FIG. 6 illustrates roughness curves P1 and P2, and an average line AL of the roughness curves P1 and P2. The roughness curve P1 corresponds to FIG. 4, and the roughness curve P2 corresponds to FIG. 5.

As described above, the surface roughness of the image development roller 315 is appropriately adjusted to satisfy a predetermined condition. Specifically, a skewness Rsk of a roughness curve (roughness curve of the surface of the image development roller 315 in the Y-axis direction), which is a characteristic average in the height direction, used as a parameter indicating the surface roughness of the image development roller 315. The skewness Rsk is 1.06 to 1.75. The value of the skewness Rsk is a value rounded to two decimal places.

The skewness Rsk of the surface of the image development roller 315 is set to be 1.06 to 1.75 to appropriately adjust the surface state (surface roughness) of the image development roller 315 degradation of the toner T is reduced while the held amount of the toner T is maintained. Accordingly, when the toner T is used to form an image on the medium M, what is called color unevenness is unlikely to occur, and what is called color cast is unlikely to occur, which results in improvement of the quality of the image. Reasons for the image quality improvement are described later in detail.

The color unevenness is failure of non-uniform concentration in an image due to an uncolored defect caused in the image when an appropriate amount of the toner T is not transferred onto the medium M. The color cast is failure of coloring of a region other than a desired image formation region on the surface of the medium M due to attachment of the toner T in a region other than a desired attachment region in the development processing (attachment of the toner T to the electrostatic latent image).

When the skewness Rsk is within the above-described range, the range of any other parameter indicating the surface roughness other than the skewness Rsk is not particularly limited. For example, a ten-point average roughness Rz of the surface of the image development roller 315 is preferably 3.00 μm to 7.00 μm. In addition, a mean spacing between peaks Sm of the surface of the image development roller 315 is preferably 0.05 μm to 0.20 μm. With these parameter values, the held amount of the toner T sufficiently increases, degradation of the toner T is sufficiently suppressed, and accordingly, the image quality sufficiently improves. The values of the ten-point average roughness Rz and the mean spacing between peaks Sm are values rounded to two decimal places.

The skewness Rsk is an index related to a surface roughness curve in the direction in which the image development roller 315 extends (the Y-axis direction). Specifically, the skewness Rsk is obtained by dividing the cubed average of Z(x) over a reference length Ir by the cube of a root-mean-square height Rq over the reference length Ir as expressed in Expressions (1) and (2) below. The skewness Rsk is a concept different from the ten-point average roughness Rz and the like typically used to indicate the surface roughness.

$$\begin{matrix}Rsk = \frac{1}{{Rq}^{3}} [ \frac{1}{Ir} {\int }_{1}^{Ir} {Z}^{3} ( x ) dx ] & ( 1 ) \\ Rq = \sqrt{\frac{1}{Ir} {\int }_{1}^{Ir} {Z}^{2} ( x ) dx} & ( 2 )\end{matrix}$$

The skewness Rsk indicates the symmetric property of hills (convex portions) and valleys (concave portions) with respect to the average line of the roughness curve, and represents what is called the degree of distortion. In a case of the skewness Rsk=0, the roughness curve is symmetric with respect to the average line. In a case of the skewness Rsk>0, the roughness curve is biased upward with respect to the average line. In a case of the skewness Rsk<0, the roughness curve is biased downward with respect to the average line.

Specifically, for example, when two kinds of the particles 3155 (3155A and 31556) having average particle sizes different from each other are used to control the surface roughness (skewness Rsk) of the image development roller 315 (surface layer 3154) as described above, the particles 3155A and 3155B are distributed on the inner side layer 3153 as illustrated in FIGS. 4 and 5.

In this case, convex portions 315P are formed on the surface of the image development roller 315 due to the existence of the particles 31556 having the larger average particle size. In addition, concave portions 315D are formed on the surface of the image development roller 315 due to the existence of the particles 3155A having the smaller average particle size.

FIG. 4 illustrates an example in which the difference between the average particle size of the particles 3155A and the average particle size of the particles 3155B is sufficiently large. In such a case, the convex portions 315P are enhanced relative to the concave portions 315D on the surface of the image development roller 315. Accordingly, as illustrated in FIG. 6 (the roughness curve P1), the positions of the bottom surfaces of the concave portions 315D are substantially maintained, the widths of the concave portions 315D are sufficiently large, and the heights of the convex portions 315P are sufficiently large. As a result, the skewness Rsk is sufficiently large on the surface of the image development roller 315.

FIG. 5 illustrates an example in which the difference between the average particle size of the particles 3155A and the average particle size of the particles 3155B is not sufficiently large. In such a case, the convex portions 315P is not enhanced relative to the concave portions 315D on the surface of the image development roller 315. Accordingly, as illustrated in FIG. 6 (the roughness curve P2), the positions of the bottom surfaces of the concave portions 315D are substantially maintained, and the widths of the concave portions 315D are sufficiently large, but the heights of the convex portions 315P are not sufficiently large. As a result, the skewness Rsk is not sufficiently large on the surface of the image development roller 315.

Since the skewness Rsk is 1.06 to 1.75 on the surface of the image development roller 315 as described above, the skewness Rsk is sufficiently larger than zero. The skewness Rsk varies not only with the difference between the average particle size of the particles 3155A and the average particle size of the particles 31556 but also with the mixture ratio of the particles 3155A and the particles 31556. More specifically, the skewness Rsk varies with, for example, the weight ratio Q described above.

The following describes in detail a reason for the image quality improvement when the skewness Rsk is within the above-described appropriate range (1.06 to 1.75).

When the skewness Rsk is within the appropriate range, the heights of the convex portions 315P are sufficiently large as illustrated in FIG. 4, and thus the depths of the concave portions 315D are sufficiently large, and the widths of the concave portions 315D are sufficiently large.

When the skewness Rsk is too small at 1.06 or less, the depths of the concave portions 315D are too small. In such a case, when the image development roller 315 is made contact with the photoreceptor drum 312 through the toner T by pressing, the toner T is likely to receive excessive pressure from the photoreceptor drum 312. Accordingly, the toner T held by the image development roller 315 at the concave portions 315D is likely to be squashed by the photoreceptor drum 312, and thus the toner T is likely to receive physical damage. Thus, color cast is likely to occur due to degradation of the toner T, and the image quality is likely to decrease. The degradation of the toner T includes, for example, damage, clumping, and charging defect of the toner T due to fall of the external additive and immersion of the external additive in toner base particles.

The factor that the toner T is likely to be squashed is not limited to the photoreceptor drum 312 but is any component of the image formation device made contact with the image development roller 315 by pressing through the toner T. Components other than the photoreceptor drum 312 as factors that the toner T is squashed are, for example, the supply roller 314 and the image development blade 316.

When the skewness Rsk is appropriately large at 1.06 or more, the depths of the concave portions 315D are appropriately large. In such a case, the toner T is unlikely to receive excessive pressure from the photoreceptor drum 312 when the image development roller 315 is made contact with the photoreceptor drum 312 by pressing through the toner T. Accordingly, the toner T held by the image development roller 315 at the concave portions 315D is unlikely to be squashed by the photoreceptor drum 312, and the toner T is unlikely to receive physical damage. Thus, color cast due to degradation of the toner T is unlikely to occur, and the image quality is unlikely to decrease.

When the skewness Rsk is too large at 1.75 or more, the depths of the concave portions 315D are too large. In such a case, an excessively large gap is formed between each of the bottom surfaces of the concave portions 315D and the photoreceptor drum 312. Accordingly, the toner T held by the image development roller 315 at the concave portions 315D is unlikely to transfer onto the surface of the photoreceptor drum 312 (the electrostatic latent image). In addition, the toner T is likely to be scraped off by the convex portions 315P due to the too large heights of the convex portions 315P, and thus the toner T attached to the electrostatic latent image is likely to be unintentionally removed. As a result, color unevenness is likely to occur due to insufficiency of the amount of toner T attached to the electrostatic latent image, and the image quality is likely to decrease.

When the skewness Rsk is appropriately small at 1.75 or less, the depths of the concave portions 315D are appropriately small. In such a case, a gap having an appropriate depth is formed between each of the bottom surfaces of the concave portions 315D and the photoreceptor drum 312. Accordingly, the toner T held by the image development roller 315 at the concave portions 315D is likely to transfer onto the surface of the photoreceptor drum 312 (the electrostatic latent image), and the toner T is unlikely to be scraped off by the convex portions 315P. As a result, color unevenness is unlikely to occur due to insufficiency of the amount of toner T attached to the electrostatic latent image, and the image quality is likely to decrease.

As described above, when the skewness Rsk is within the appropriate range (1.06 to 1.75), the heights of the convex portions 315P and the depths of the concave portions 315D are appropriately adjusted. Accordingly, color unevenness and color cast are unlikely to occur, and the image quality is unlikely to decrease.

The skewness Rsk is measured by using, for example, a surface-roughness figure-shape measuring instrument SURFCORDER SEF3500 manufactured by Kosaka Laboratory Ltd. Measurement conditions are, for example, as follows: Measurement direction=Direction in which the image development roller 315 extends (the Y-axis direction); Cutoff=0.8 mm; Filter characteristic=Gauss; Evaluation length=Cutoff×5; and Measurement speed=1 mm/sec.

The above-described value of the skewness Rsk is the average value of 12 values of the skewness Rsk measured at 12 measurement points T1 to T12 on the surface of the image development roller 315 as illustrated in FIG. 3. The measurement points T1 to T4 are four measurement places set separately from each other on the outer peripheral surface of the image development roller 315 on one end side in the direction in which the image development roller 315 extends. The measurement points T5 to T8 are four measurement places set separately from each other on the outer peripheral surface of the image development roller 315 on the other end side in the direction in which the image development roller 315 extends. The measurement points T9 to T12 are four measurement places set separately from each other on the outer peripheral surface of the image development roller 315 between the measurement points T1 to T4 and the respective measurement points T5 to T8 in the direction in which the image development roller 315 extends.

The angle between the straight line connecting the measurement point T1 and the rotational axis 315X and the straight line connecting the measurement point T2 and the rotational axis 315X is 90°. The angle between the straight line connecting the measurement point T2 and the rotational axis 315X and the straight line connecting the measurement point T3 and the rotational axis 315X is 90°. The angle between the straight line connecting the measurement point T3 and the rotational axis 315X and the straight line connecting the measurement point T4 and the rotational axis 315X is 90°. The angle between the straight line connecting the measurement point T4 and the rotational axis 315X and the straight line connecting the measurement point T1 and the rotational axis 315X is 90°. The positional relation among the measurement points T1 to T4 described above is same for the positional relation among the measurement points T5 to T8 and the positional relation among the measurement points T9 to T12.

### <1-4. Block Configuration>

The following describes a block configuration of the image formation device. FIG. 7 illustrates a block configuration of the image formation device illustrated in FIG. 1. FIG. 7 also illustrates some of the already described components of the image formation device.

As illustrated in FIG. 7, the image formation device includes, for example, an image formation control unit 71, an interface (I/F) control unit 72, a reception memory 73, an edition memory 74, an operation panel 75, various sensors 76, a light source control unit 77, a charge voltage control unit 78, a supply voltage control unit 79, an image development voltage control unit 80, a transfer voltage control unit 81, a roller drive control unit 82, a drum drive control unit 83, a belt drive control unit 84, and a fixation control unit 85.

### [Image Formation Control Unit]

The image formation control unit 71 controls the entire operation of the image formation device. The image formation control unit 71 includes, for example, one kind or two or more kinds of electronic components such as a control circuit, a memory, input and output ports, and a timer. The control circuit includes, for example, a central processing unit (CPU). The memory includes, for example, one kind or two or more kinds of storage elements such as a read-only memory (ROM) and a random access memory (RAM).

### [I/F Control Unit]

The I/F control unit 72 receives information such as data transmitted from an external device to the image formation device. The external device is, for example, a personal computer that can be used by a user of the image formation device. The information transmitted from the external device to the image formation device is, for example, image data used to form an image.

### [Reception Memory and Edition Memory]

The reception memory 73 stores information such as data received by the image formation device. The data is, for example, the above-described image data. The edition memory 74 stores, for example, data (edited image data) obtained by editing image data.

### [Operation Panel]

The operation panel 75 is, for example, a display device that displays information needed by the user to operate the image formation device, and is an input device used by the user to operate the image formation device. The operation panel 75 includes, for example, a display panel and an operation button. The display panel is not limited to a particular kind but is, for example, a liquid crystal panel of a touch panel scheme.

### [Various Sensors]

The various sensors 765 include, for example, one kind or two or more kinds of a temperature sensor, a humidity sensor, an image concentration sensor, a medium position detection sensor, a toner remaining amount sensing sensor, a person sensing sensor, and the like.

### [Light Source Control Unit, Charge Voltage Control Unit, Supply Voltage Control Unit, Image Development Voltage Control Unit, and Transfer Voltage Control Unit]

The light source control unit 77 controls, for example, an exposure operation of the light source 33. The charge voltage control unit 78 controls, for example, voltage applied to the charge roller 313. The supply voltage control unit 79 controls, for example, voltage applied to the supply roller 314. The image development voltage control unit 80 controls, for example, voltage applied to the image development roller 315. The transfer voltage control unit 81 controls, for example, voltage applied to each of the primary transfer roller 45 and the secondary transfer roller 46. These voltages can be set, for example, in accordance with instructions from the image formation control unit 71.

Although not illustrated in FIG. 7 for simplification, the image formation device includes, for example, the four light source control units 77 corresponding to the four image development units 30 (30K, 30Y, 30M, and 30C). Specifically, the four light source control units 77 are, for example, the light source control unit 77 that controls the light source 33 attached to the image development unit 30K, the light source control unit 77 that controls the light source 33 attached to the image development unit 30Y, the light source control unit 77 that controls the light source 33 attached to the image development unit 30M, and the light source control unit 77 that controls the light source 33 attached to the image development unit 30C.

The above description on the light source control units 77 also applies to, for example, the charge voltage control unit 78, the supply voltage control unit 79, the image development voltage control unit 80, and the transfer voltage control unit 81. Specifically, the image formation device includes, for example, the four charge voltage control units 78, the four supply voltage control units 79, the four image development voltage control units 80, and the four transfer voltage control unit 81, which correspond to the four image development units 30 and the four primary transfer rollers 45.

### [Roller Drive Control Unit]

The roller drive control unit 82 controls, for example, through the roller motor 86, rotation operation of a series of rollers such as the feed roller 20, the drive roller 42, the primary transfer roller 45, the secondary transfer roller 46, the heating roller 51, the pressing roller 52, the conveyance rollers 61 to 68, the supply roller 314, and the image development roller 315.

The above description on the light source control units 77 also applies to, for example, the roller drive control unit 82. Specifically, the image formation device includes, for example, the four roller drive control units 82 that control rotation operation and the like of the four primary transfer rollers 45 (45K, 45Y, 45M, and 45C), the four roller drive control units 82 that control rotation operation and the like of the four image development rollers 315, which correspond to the four image development units 30.

### [Drum Drive Control Unit, Belt Drive Control Unit, and Fixation Control Unit]

The drum drive control unit 83 controls, for example, rotation operation and the like of the photoreceptor drum 312 through a drum motor 87. The belt drive control unit 84 controls, for example, movement operation and the like of the intermediate transfer belt 41 through a belt motor 88. The fixation control unit 85 controls, for example, heating operation of the heater 89 based on a temperature measured by the thermistor 90, and controls rotation operation and the like of each of the heating roller 51 and the pressing roller 52 through a fixation motor 91.

The above description on the light source control units 77 also applies to, for example, the drum drive control unit 83. Specifically, the image formation device includes, for example, the four drum drive control units 83 corresponding to the four image development units 30.

### <1-5. Operation>

The following describes operation of the image formation device.

To form an image on the medium M by using the toner T, the image formation device performs, for example, development processing, primary transfer processing, secondary transfer processing, and fixation processing in the stated order as described below, and performs cleaning processing as necessary. This series of processing is controlled by, for example, the image formation control unit 71.

### [Development Processing]

First, the medium M housed in the tray 10 is taken out by the feed roller 20 and conveyed along the conveyance path R1 in the direction of Arrow F1 by the conveyance rollers 61 and 62.

In the image development unit 30 (development processing unit 31), when the photoreceptor drum 312 rotates, direct-current voltage is applied to the photoreceptor drum 312 in accordance with rotation of the charge roller 313 to uniformly charge the surface of the photoreceptor drum 312. Subsequently, when the light source 33 irradiates the surface of the photoreceptor drum 312 with light based on the edited image data, potential attenuates (light attenuation) in the irradiation region of the light, thereby forming an electrostatic latent image.

In the development processing unit 31, the supply roller 314 and the image development roller 315 rotate in accordance with the voltage application so that the toner T is supplied from the supply roller 314 to the image development roller 315. The toner T transfers from the image development roller 315 to the photoreceptor drum 312 in accordance with rotation of the photoreceptor drum 312 and attaches to the photoreceptor drum 312 (the electrostatic latent image). In such a case, part of the toner T is removed by the image development blade 316 to regulate (uniform) the thickness of the toner T.

In the image development unit 30 (toner cartridge 32), when the supply roller 314 rotates in accordance with the voltage application, the toner T housed in the housing chamber 321 is agitated and thus supplied from the toner cartridge 32 to the development processing unit 31.

### [Primary Transfer Processing]

Subsequently, in the transfer unit 40, when the drive roller 42 rotates, the driven roller 43 and the backup roller 44 rotate in accordance with the rotation of the drive roller 42 to move the intermediate transfer belt 41 in the direction of Arrow F5. In such a case, when voltage is applied to the primary transfer roller 45 in contact with the photoreceptor drum 312 by pressing through the intermediate transfer belt 41, the toner T attached to the surface of the photoreceptor drum 312 (the electrostatic latent image) through the development processing is transferred onto the intermediate transfer belt 41.

### [Secondary Transfer Processing]

Subsequently, when voltage is applied to the secondary transfer roller 46 in contact with the backup roller 44 by pressing through the medium M as the medium M passes between the backup roller 44 and the secondary transfer roller 46, the toner T transferred onto the intermediate transfer belt 41 through the primary transfer processing is transferred onto the medium M.

### [Fixation Processing]

Lastly, in the fixation unit 50, the medium M passes between the heating roller 51 and the pressing roller 52. In such a case, the toner T transferred onto the medium M is melted through heating by the heating roller 51, and made contact with the medium M by pressing by the pressing roller 52. Accordingly, the toner T closely contacts with the medium M.

As a result, the toner T is fixed to the medium M so that an image is formed on the medium M. The medium M on which the image is formed is conveyed along the conveyance path R2 in the direction of Arrow F2 by the conveyance rollers 63 and 64, and then discharged to the stacker 2 through the discharge port 1H.

The kind (color and number) of toner T used to form an image is determined in accordance with a combination of colors necessary for forming the image. Specifically, for example, the black toner is used to form a monochrome image. For example, to form a color image, one kind or two or more kinds of the yellow toner, the magenta toner, and the cyan toner are used, and the black toner is used as necessary.

When images are to be formed on both surfaces of the medium M, for example, the medium M having passed through the fixation unit 50 is conveyed along the conveyance paths R3 to R5 in the directions of Arrows F3 and F4 by the conveyance rollers 65 to 68. Thereafter, the medium M is conveyed again along the conveyance path R1 in the direction of Arrow F1 by the conveyance rollers 61 and 62. In this case, the direction in which the medium M is conveyed is switched by the conveyance path switching guides 69 and 70. Accordingly, the back surface (surface on which an image is yet to be formed) of the medium M is provided with the development processing, the primary transfer processing, the secondary transfer processing, and the fixation processing.

### [Cleaning Processing]

In the image development unit 30, as the photoreceptor drum 312 rotates in contact with the cleaning blade 317 by pressing, any foreign object such as unnecessary toner T remaining on the surface of the photoreceptor drum 312 is scraped off by the cleaning blade 317. In the transfer unit 40, as the intermediate transfer belt 41 moves, any foreign object such as unnecessary toner T remaining on the surface of the intermediate transfer belt 41 is scraped off by the cleaning blade 47.

### <1-6. Operations and Effects>

According to the image formation device, the skewness Rsk of the surface of the image development roller 315 is 1.06 to 1.75. In such a case, as described above, the heights of the convex portions 315P and the depths of the concave portions 315D on the surface of the image development roller 315 are appropriately adjusted so that color unevenness and color cast are unlikely to occur to an image formed on the medium M. Accordingly, the image quality is unlikely to decrease, and thus the image is formed at high quality.

In particular, when the ten-point average roughness Rz of the surface of the image development roller 315 is 3.00 μm to 7.00 μm and the mean spacing between peaks Sm of the surface of the image development roller 315 is 0.05 μm to 0.20 μm, the held amount of the toner T is sufficiently increased and degradation of the toner T is sufficiently reduced, thereby achieving the higher effect.

When the image development roller 315 includes the shaft 3151 and the cover layer 3152, more specifically, when the cover layer 3152 includes the inner side layer 3153 and the surface layer 3154, the image development roller 315 closely contacts with the photoreceptor drum 312, thereby achieving the higher effect.

In this case, when the surface layer 3154 contains the elastic material and the particles 3155 and the particles 3155 contain urethane resin or the like, the skewness Rsk is likely to be controlled to be within the above-described appropriate range by using the particles 3155, thereby achieving the higher effect.

When the particles 3155 include the particles 3155A (the median diameter D50=3 μm to 7 μm) and the particles 3155B (the median diameter D50=10 μm to 20 μm), the weight fraction M is 35% by weight or lower, and the weight ratio Q is 0.25 to 1.00, the skewness Rsk is likely to be appropriately adjusted to the above-described range, thereby achieving the higher effect.

When the supply roller 314 and the image development blade 316 are attached to the image development roller 315, degradation of the toner T due to contact with the supply roller 314 and the image development blade 316 by pressing is reduced, thereby achieving the higher effect.

### <2. Modifications>

In the example illustrated in FIG. 4, the two kinds of the particles 3155 having two kinds of average particle sizes different from each other are used as the particles 3155 to achieve the skewness Rsk within the appropriate range (=1.06 to 1.75).

However, three or more kinds of the particles 3155 having three or more kinds of average particle sizes different from one another may be used to achieve the skewness Rsk within the appropriate range. In such a case, too, color unevenness and color cast are unlikely to occur with the skewness Rsk within the appropriate range, thereby achieving the same effect.

In the example illustrated in FIG. 3, the cover layer 3152 has a two-layer structure including the inner side layer 3153 and the surface layer 3154.

However, the number of layers in the cover layer 3152 is not particularly limited as long as the skewness Rsk is within the appropriate range. Thus, the cover layer 3152 may have a multi-layer structure including three or more layers. In such a case, too, color unevenness and color cast are unlikely to occur with the skewness Rsk within the appropriate range, thereby achieving the same effect.

### Example

The following describes an example of this disclosure in detail. The description is made in the following order.

1. Production of image development roller
2. Image evaluation

### 3. Discussion

### 4. Conclusion

### <1. Production of Image Development Roller>

The image development roller 315 was produced through the following procedure.

First, the shaft 3151 (diameter=10 mm) made of iron and provided with electroless nickel plating processing was prepared. Subsequently, the shaft 3151 was cleaned by using an organic solvent (toluene), and then silicone primer was applied on the surface of the shaft 3151. Subsequently, the shaft 3151 was fired (firing time=10 minutes) by using a gear oven (temperature=150° C.), and then cooled at room temperature (temperature=23° C.). As a result, a primer layer was formed on the surface of the shaft 3151.

Subsequently, a silicone rubber composition was supplied to the surface of the shaft 3151, and shaped by a mold shaping method while being heated. Accordingly, the inner side layer 3153 was formed.

Subsequently, the elastic material (urethane resin), the particles 3155 (polyurethane urea particle), and the organic solvent (toluene) were mixed together and agitated to prepare solution (application liquid). The particles 3155 were the particles 3155A having the smaller average particle size (the median diameter D50=5 μm), and the particles 3155B having the larger average particle size (the median diameter D50=10 μm). Lastly, the application liquid was applied on the surface of the inner side layer 3153 by a roll coating method and dried (cured) to form the surface layer 3154. In addition, the surface layer 3154 containing no particles 3155 (3155A and 3155B) and thus no particles 3155 was formed for comparison.

In this case, the existence, mixture ratio (weight fractions M, M1, and M2) and weight ratio Q of the particles 3155A and 3155B were set as indicated in Table 1. Accordingly, the surface properties of the surface layer 3154, in other words, the skewness Rsk, the ten-point average roughness Rz (μm), and the mean spacing between peaks Sm (μm) were set as indicated in Table 2. The weight fractions M, M1, and M2 and the weight ratio Q are defined as described above.

TABLE 1

| | Weight | Weight | Weight | |
|---|---|---|---|---|
| Experiment | Fraction M1 | Fraction M2 | Fraction M | Weight |
| Example | (% by weight) | (% by weight) | (% by weight) | Ratio Q |
| 1 | — | — | — | — |
| 2 | — | — | — | — |
| 3 | — | — | — | — |
| 4 | 20 | 5 | 25 | 0.25 |
| 5 | 15 | 5 | 20 | 0.33 |
| 6 | 20 | 10 | 30 | 0.50 |
| 7 | 15 | 10 | 25 | 0.67 |
| 8 | 20 | 15 | 35 | 0.75 |
| 9 | 15 | 15 | 30 | 1.00 |
| 10 | 20 | 20 | 40 | 1.00 |

TABLE 2

| | | | | Image | | |
|---|---|---|---|---|---|---|
| | | | | Quality | Image Quality | |
| Experiment | | | | (Color | Color | Change |
| Example | Rsk | Rz (μm) | Sm (μm) | Unevenness) | Cast | Rate |
| 1 | 0.44 | 4.19 | 0.08 | A | B | 0.61 |
| 2 | 0.70 | 3.29 | 0.17 | A | B | 0.60 |
| 3 | 0.90 | 4.77 | 0.19 | A | B | 0.65 |
| 4 | 1.06 | 3.00 | 0.05 | A | A | 0.70 |
| 5 | 1.06 | 5.10 | 0.08 | A | A | 0.71 |
| 6 | 1.20 | 4.61 | 0.19 | A | A | 0.79 |
| 7 | 1.55 | 5.15 | 0.16 | A | A | 0.83 |
| 8 | 1.75 | 5.07 | 0.14 | A | A | 0.85 |
| 9 | 1.75 | 7.00 | 0.20 | A | A | 0.86 |
| 10 | 2.03 | 3.20 | 0.16 | B | A | 0.86 |

As a result, the cover layer 3152 including the inner side layer 3153 and the surface layer 3154 was formed to cover the surface of the shaft 3151, which completed the image development roller 315 (outer diameter=16 mm).

### <2. Image Evaluation>

An image was formed on the surface of the medium M by using an image formation device on which the image development roller 315 described above was mounted. Thereafter, the quality (image quality) of the image was evaluated to obtain results indicated in Table 2. In this example, influence of color unevenness on the image quality, and influence of color cast on the image quality were measured to evaluate the image quality.

The image was formed by using the image formation device under an environment condition of room temperature environment (temperature=23° C. and humidity=50%). The image formation device was a color printer manufactured by Oki Data Corporation. The medium M was an A4 printer sheet (excellent gloss, and size=297 mm×210 mm) manufactured by Oki Data Corporation.

To measure the influence of color unevenness on the image quality, an image (image pattern=solid, and printing rate=100%) was formed on the surface of the medium M by using the toner T (black toner), and the state of the image was visually checked to determine the image quality. As a result, a case in which no color unevenness occurred with no observed minute uncolored defects was determined to be “A”. Alternatively, a case in which color unevenness occurred with observed minute uncolored defects was determined to be “B”.

To measure the influence of color cast on the image quality, an image (image pattern=halftone, and printing rate=25%) was formed on the surface of the medium M by using the toner T (black toner), and the state of the image was visually checked to determine the image quality. As a result, a case in which no color cast occurred with no coloring in a region other than a desired image formation region was determined to be “A”. Alternatively, a case in which color cast occurred with coloring in a region other than the desired image formation region was determined to be “B”.

As described above, color cast is likely to occur due to physical damage on the toner T. Thus, when the influence of color cast on the image quality was measured, a change rate as an index indicating the amount of physical damage on the toner T was additionally calculated through a procedure described below to quantify the physical damage.

To calculate the change rate, first, a BET specific surface area (before-use specific surface area) of the toner T was measured before an image was formed by using the toner T. The BET specific surface area was measured by using an automatic specific surface area and pore distribution measurement device TriStar3000 (manufactured by Shimadzu Corporation; measurement scheme=constant-volume gas adsorption method) connected with a vacuum pump, a nitrogen gas pipe, and a helium gas pipe. Measurement condition setting and measurement data analysis were performed by using dedicated software TriStar3000 Version 4.00 accompanying the above-described measurement device. Subsequently, the process of forming an image on the surface of the medium M by using the image formation device on which the toner T was mounted was repeated (image pattern=solid, printing rate=100%, image formation speed=40 rpm, traveling direction of the medium M=long-side direction of the medium M in A4 size, and image formation frequency=30000). Subsequently, the toner T was collected from the image formation device, and then the BET specific surface area (after-use specific surface area) of the toner T was measured again. Lastly, the change rate of “after-use specific surface area”/“before-use specific surface area” was calculated. The value of the change rate value was rounded to two decimal places.

### <3. Discussion>

The image quality largely varied with the configuration (M, M1, M2, and Q) and surface properties (Rsk, Rz, and Sm) of the image development roller 315.

Specifically, when the skewness Rsk was smaller than 1.06 (Experiment Examples 1 to 3), no color unevenness occurred, but color cast occurred. When the skewness Rsk was larger than 1.75 (Experiment Example 10), no color cast occurred, but color unevenness occurred.

When the skewness Rsk was 1.06 to 1.75 (Experiment Examples 4 to 9), no color unevenness occurred, and no color cast occurred.

The change rate varied with the skewness Rsk, and accordingly, the occurrence of color cast varied with the change rate. Specifically, color cast occurred when the amount of physical damage on the toner T was large and thus the change rate was small (Experiment Examples 1 to 3). No color cast occurred when the amount of physical damage on the toner T was small and thus the change rate was large (Experiment Examples 4 to 10). In this case, as the skewness Rsk increased, the change rate increased and thus color cast became unlikely to occur.

In particular, when the skewness Rsk was 1.06 to 1.75 (Experiment Examples 4 to 9), the ten-point average roughness Rz was 3.00 μm to 7.00 μm and the mean spacing between peaks Sm was 0.05 μm to 0.20 μm. In this case, no color unevenness nor color cast occurred, and thus the image quality was excellent.

When the particles 3155 included in the particles 3155A (the median diameter D50=5 μm) and the particles 3155B (the median diameter D50=10 μm) having average particle sizes different from each other, the weight fraction M was 35% by weight or lower and the weight ratio Q was 0.25 to 1.00 (Experiment Examples 4 to 9). In this case, the skewness Rsk was appropriately adjusted as described above, and thus the image quality was excellent.

### <4. Conclusion>

According to the results indicated in Table 2, no color unevenness nor color cast occurred when the skewness Rsk of the surface of the image development roller 315 was 1.06 to 1.75. Accordingly, the image quality was unlikely to decrease, and thus a high-quality image was formed.

The disclosure is described above with reference to the one or more embodiments and examples, but the invention is not limited to an aspect described in the above embodiments and examples. Accordingly, the aspect of the invention may be modified in various manners.

Specifically, for example, the image formation device is not limited to an image formation device of the intermediate transfer scheme that uses an intermediate transfer medium, but may be an image formation device of a direct transfer scheme that uses no intermediate transfer medium. Moreover, for example, the image formation device is not limited to a printer, but may be another device such as a copier, a facsimile, or a complex machine.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

1. An image development unit comprising:
an electrostatic latent image carry member that carries an electrostatic latent image; and
an image development member that attaches toner to the electrostatic latent image and includes a surface with a skewness Rsk of 1.06 to 1.75 inclusive.

2. The image development unit according to claim 1, wherein the image development member includes
a conductive shaft member, and
a conductive elastic layer covering a surface of the shaft member.

3. The image development unit according to claim 2, wherein
the elastic layer contains a plurality of particles,
the plurality of particles includes
first particles with a median diameter D50 of 3 μm to 7 μm inclusive, and
second particles with a median diameter D50 of 10 μm to 20 μm inclusive, and
a ratio of the weight of the second particles relative to the weight of the first particles is 0.25 to 1.00 inclusive.

4. The image development unit according to claim 3, wherein
the elastic layer contains
a first elastic layer covering the surface of the shaft member and that contains silicone rubber as a first elastic material, and
a second elastic layer covering a surface of the first elastic layer and that contains urethane resin as a second elastic material.

5. The image development unit according to claim 4, wherein
the plurality of particles are contained in the second elastic layer, and
a ratio of the sum of the weight of the first particles and the weight of the second particles relative to the weight of the second elastic material is 35% by weight or lower.

6. The image development unit according to claim 1, wherein
a ten-point average roughness Rz of the surface of the image development member is 3.00 μm to 7.00 μm inclusive, and
a mean spacing between peaks Sm of the surface of the image development member is 0.05 μm to 0.20 μm inclusive.

7. The image development unit according to claim 1, further comprising:
a supply member that supplies the toner to the image development member; and
a regulation member that regulates a thickness of a layer of the toner supplied to the image development member.

8. An image formation device comprising the image development unit according to claim 1.

9. An image development unit comprising:
an electrostatic latent image carry member that carries an electrostatic latent image; and
an image development member that attaches toner to the electrostatic latent image and includes a conductive shaft member and a conductive elastic layer covering a surface of the shaft member, wherein
the elastic layer contains a plurality of particles,
the plurality of particles includes
first particles with a median diameter D50 of 3 μm to 7 μm inclusive, and
second particles with a median diameter D50 of 10 μm to 20 μm inclusive, and
a ratio of the weight of the second particles relative to the weight of the first particles is 0.25 to 1.00 inclusive.

10. The image development unit according to claim 9, wherein
the elastic layer contains
a first elastic layer covering the surface of the shaft member and that contains silicone rubber as a first elastic material, and
a second elastic layer covering a surface of the first elastic layer and that contains urethane resin as a second elastic material.

11. The image development unit according to claim 10, wherein
the plurality of particles are contained in the second elastic layer, and
a ratio of the sum of the weight of the first particles and the weight of the second particles relative to the weight of the second elastic material is 35% by weight or lower.

12. The image development unit according to claim 9, wherein
a ten-point average roughness Rz of a surface of the image development member is 3.00 μm to 7.00 μm inclusive, and
a mean spacing between peaks Sm of the surface of the image development member is 0.05 μm to 0.20 μm inclusive.

12. The image development unit according to claim 9, further comprising:
a supply member that supplies the toner to the image development member; and
a regulation member that regulates a thickness of a layer of the toner supplied to the image development member.

13. An image formation device comprising the image development unit according to claim 9.
